(19) United States
(12) Patent Application Publication
(10) Pub. No.: US 2004/0021318 A1
(43) Pub. Date: Feb. 5, 2004

(54) Tubing attachment

(76) Inventors: Karl Fritze, Denmark Township, MN (US); Nathan E. Marks, Savage, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/210,776

(22) Filed: Jul. 31, 2002

(51) Int. Cl. F16L 13/02

(52) U.S. Cl. 285/340; 285/21.1

(57) ABSTRACT

An apparatus for creating a permanent and fluid tight tube joint in a length of plastic tubing, the tubing including a terminal end, the apparatus including a manifold for receiving the plastic tubing, the manifold including structure defining a first counterbore presenting a tubing terminal end engaging face, structure defining a second counterbore presenting a seal engaging face, and the manifold further presenting a manifold coupling face. A seal is receivable within the second counterbore and a gripping element is receivable within the manifold and adapted for fixedly engaging the tubing. A retainer includes a compressive member and a retainer coupling face, the retainer compressive member receivable within the second counterbore for operably, compressively engaging the seal. The retainer coupling face and the manifold coupling face are mutually abuttably oriented when the retainer compressive member is received within the second counterbore, whereby the manifold coupling face and the retainer coupling face can be operably fixedly coupled together to permanently attach the retainer and manifold together with the seal compressed to provide a fluid tight coupling of the tubing with the manifold.

### FIELD OF THE INVENTION

The present invention relates generally to the field of forming joints for plastic tubing. More specifically, the present invention relates to a method of forming a permanent, leak-proof joint with plastic tubing, particularly plastic tubing made of high performance polymers.

### BACKGROUND OF THE INVENTION

Since its invention, plastic tubing has increasingly been used in residential, commercial and industrial applications that were previously the domain of brass, copper and steel tubing. Plastic tubing offers many advantages over its metal predecessors. Plastic tubing is extremely flexible allowing for quick and easy installation as compared to metal tubing. In the case of demanding applications, the wide variety of available plastic polymers allows a user to select chemically inert and resistant tubing to meet the unique requirements of the application. Finally, nearly anyone can install plastic tubing, as it does not require the skill set that typical metal tubing installations require.

A variety of methods have been developed for creating joints with plastic tubing. Most methods involve mechanical couplings providing temporary connections. Because the typical mechanical connection functions only due to a temporary mechanical seal, the potential for leaking is present when using such connections. Examples of these types of mechanical connections include the use of ferrules with a crimp process, push-style fittings such as those manufactured by John Guest International Ltd. and threaded style compression fittings such as those manufactured by JACO Manufacturing Company.

When users confront demanding applications, they typically select the appropriate tubing based on the polymer which best provides characteristics for their application. Many users will select specialty plastic polymers such as Polyvinylidene Fluoride (PVDF), Teflon® and cross-linked Polyethylene (PEX) when the demands of the application require concern for chemical compatibility or elevated temperature issues. Unfortunately, many of the characteristics that make the use of specialty plastics desirable also lead to difficulties when a user attempts to create tubing joints. Subsequently, the user's ability to create permanent, leak-proof joints with these specialty plastics exceeds the problems associated with more standard polymers such as nylon, polyethylene and polypropylene.

An example of the types of problems associated with creating permanent, leak-proof joints is demonstrated by PEX tubing. There are several methods of manufacturing PEX. The fundamental result is that the molecular chains of polyethylene are cross-linked resulting in a polymer that shows strength and durability over a wide temperature range. Unfortunately, this strength and durability prevents PEX from exhibiting the chemical and adhesive bonding traits that are common with other polymers. Because of this limitation, a variety of mechanical means for creating joints with PEX tubing have been developed. These means typically include crimping means and metal tubing inserts.

An example of such mechanical means include the Vanguard CRIMPSERT™ metallic insert fitting. The CRIMPSERT™ fitting uses insert fittings and crimp rings made of copper or brass. Using a crimping tool, the user is able to mechanically seal the joint. Another example of such mechanical sealing means includes the Wirsbo ProPEX® fitting system. The ProPEX® system uses the shaped-memory characteristic of PEX. An expander tool is used to expand an end of the PEX tubing. An insert fitting is inserted into this expanded tubing and the expander tool is then removed. The tubing returns to its original shape thereby compressing and holding the insert fitting in place.

While mechanical sealing means may be suitable for creating joints in plastic tubing for residential and commercial installations, these mechanical sealing means provide little value in large volume commercial and manufacturing settings. What is required and what this invention provides is a joint forming technique for plastic tubing, especially tubing constructed of specialty plastic polymers, allowing for a quick, leak-proof, and permanent connection of plastic tubing joints that is also swiftly repeatable from joint to joint.

### SUMMARY OF THE INVENTION

The tubing connector and joint forming technique of the present invention satisfy the requirements for sealing plastic tubing in high volume settings. The tubing connector includes a tubing retainer bonded to a tubing manifold to effect a permanent, leak-proof tubing connection independent of the polymer composition of the tubing.

A tubing retainer of the present invention is readily matable with and permanently connected to a tubing manifold of the present invention, providing a continuous flow path for the tubing contents. The preferred method of joining the manifold to the retainer is through sonic welding, although other coupling methods may be used. At least one seal provides a watertight seal between the interior of the tubing manifold and the external environment. A non-releasable washer prevents extraction of the tubing once the tubing connector is assembled.

In assembly, tubing is first inserted through the tubing retainer. The exposed end of this tubing is then inserted through a seal, and further through a washer. Once the retainer, seal, and washer have been placed over the tubing, the tubing is inserted into the tubing manifold bore. As the tubing engages the manifold, the washer will come in contact with a seal face within the manifold bore, preventing further travel of the seal, washer, and retainer. Insertion of the tubing will continue until the end of the tubing contacts a tube face within the manifold bore. A force applicator is then applied to the retainer, compressing the retainer, seal, and washer into the manifold. After compression, the force applicator is used to apply a vibratory motion to the retainer to sonically weld the retainer to the manifold, while at the same time further compressing the connector components.

A critical aspect of the aforementioned embodiment is the permanence of the assembly. The sonically welded retainer is not disengagable from the tubing manifold. Further, because of the sonic weld between the tubing retainer and manifold, the retaining washer is inaccessible, such that extraction of the tubing is not possible without severe destruction to the tubing.

Another feature of the present invention is the enhanced sealing provided by the method of assembly. The force applicator and subsequent compression during sonic welding after the tubing has been inserted within the manifold serve to further compress the seal to the tubing beyond what could be accomplished by insertion of the tubing alone. This additional compression consequently effects a superior watertight seal.

The preferred embodiment described above makes use of a stationary device capable of providing both compressive force as well as a sonic transmission. Such a device allows for high volume use of the invention while at the same time maintaining a high degree of repeatability. Examples of assemblies in which the embodiment could be practiced include water filtration equipment, appliances, and plumbing assemblies.

One alternative embodiment includes the use of the fitting components of the present invention in connecting and sealing a plurality of tubing runs into a single, continuous tube circuit.

Another embodiment includes a portable device capable of supplying the sonic energy and compressive force generating device that would allow the invention to be used in locations other than in high-volume, production settings. Such a device could include a handheld design allowing the invention to be practiced in areas including building construction, plumbing repair and replacement and in other remote locations where a stationary device is either unavailable or impractical.

Another embodiment of the present invention includes preassembling the filter components absent the tubing. In this embodiment, the preassembled fitting could be sent to a second location where it could be mated with the plastic tubing. In this embodiment, the device capable of supplying sonic and compressive force would only be required during assembly of the components and not during insertion of the tubing.

### BRIEF DESCRIPTION OF THE DRAWINGS

FIG. 1 is an exploded perspective view of a tubing attachment in accordance with the present invention;

FIG. 2 is a sectional view of the tubing attachment manifold;

FIG. 3 is a sectional view of the tubing attachment retainer;

FIG. 4 is a sectional view of tubing;

FIG. 5 is an end view of the locking surface of the tubing attachment washer;

FIG. 6 is a perspective view of the sealing surface of the washer;

FIG. 7 is an elevational view of an assembled tubing attachment;

FIG. 8 is a sectional view of an assembled tubing attachment;

FIG. 9 is a sectional view of an alternative embodiment of the tubing attachment; and

FIG. 10 is a sectional view of the connector assembly of the tubing attachment of FIG. 9, but without tubing.

### DETAILED DESCRIPTION OF THE DRAWINGS

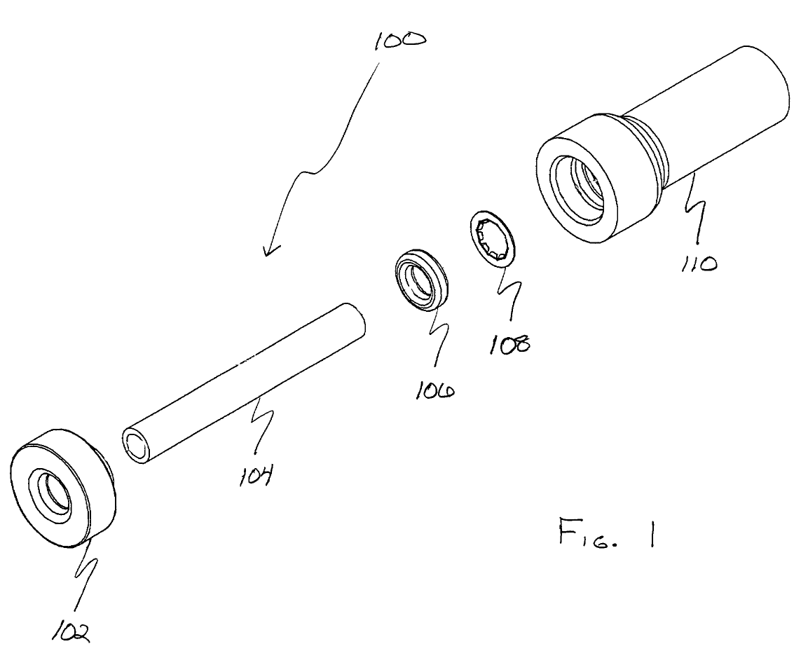

Referring in particular to FIG. 1, a tube connector 100 in accordance with the present invention includes a retainer 102 adapted to receive tubing 104, a seal 106, a star washer 108 and a manifold 110. It is to be understood that the manifold 110 could be formed integral with or joined to filtration equipment or plumbing assemblies. The manifold 110 could further be formed with mirror image ends for joining two lengths of tubing 104.

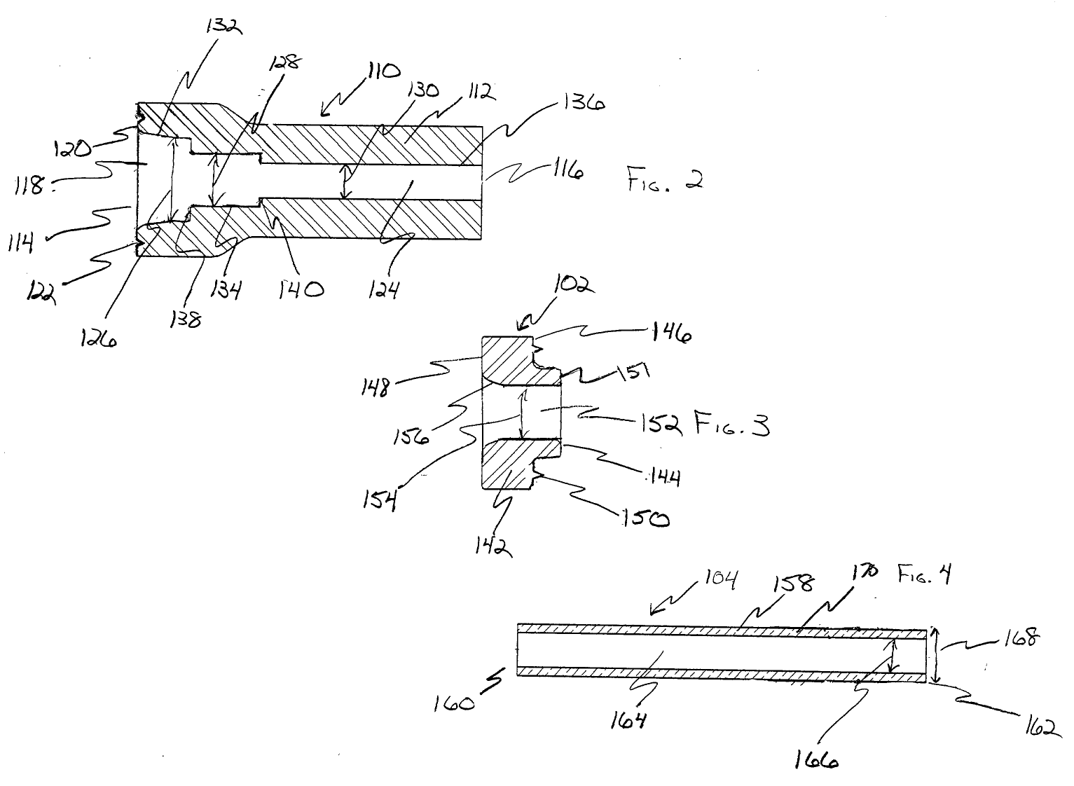

FIGS. 2, 3 and 4 are sectional views of the individual components comprising the tube connector 100. FIG. 2 depicts a section of the manifold 110. The manifold 110 can be formed from a polymer. The manifold 110 has an attachment end 114 and a mounting end 116. Attachment end 114 includes a receiver bore 118 and a manifold coupling face 120. Manifold coupling face 120 contains a weld receiver 122 that is an annular groove formed in the manifold coupling face 120.

Manifold 110 includes a continuous manifold through-bore 124 defined by mounting end 116 and attachment end 114. Manifold bore 124 presents a first diameter 126, a second diameter 128 and a third diameter 130 in sequence from the attachment end 114. First diameter 126 is defined by a tapered manifold surface 132. Second diameter 128 is defined by a tubing interface surface 134. Third diameter 130 is defined by a flow surface 136. Manifold 110 further includes a sealing face 138 and a tube face 140 within manifold bore 124. In alternative embodiments, mounting end 116 could be replaced with a second attachment end 114. The manifold 110 could also comprise a further plurality of attachment ends 114 such that a single manifold 110 in a T or Y configuration could connect a plurality of tubing 104, as noted above.

Referring to FIG. 3, retainer 102 includes a compression face 144 on an annular boss 151, a retainer coupling face 146 and an insertion face 148. The retainer 102 can be formed from a polymer. Retainer coupling face 146 includes a weld insert 150. Retainer 102 contains a retainer bore 152 defined by compression face 144 and insertion face 148. Retainer bore 152 presents a retainer diameter 154. Insertion face 148 transitions into retainer bore 152 through a tapered or flared retainer surface 156.

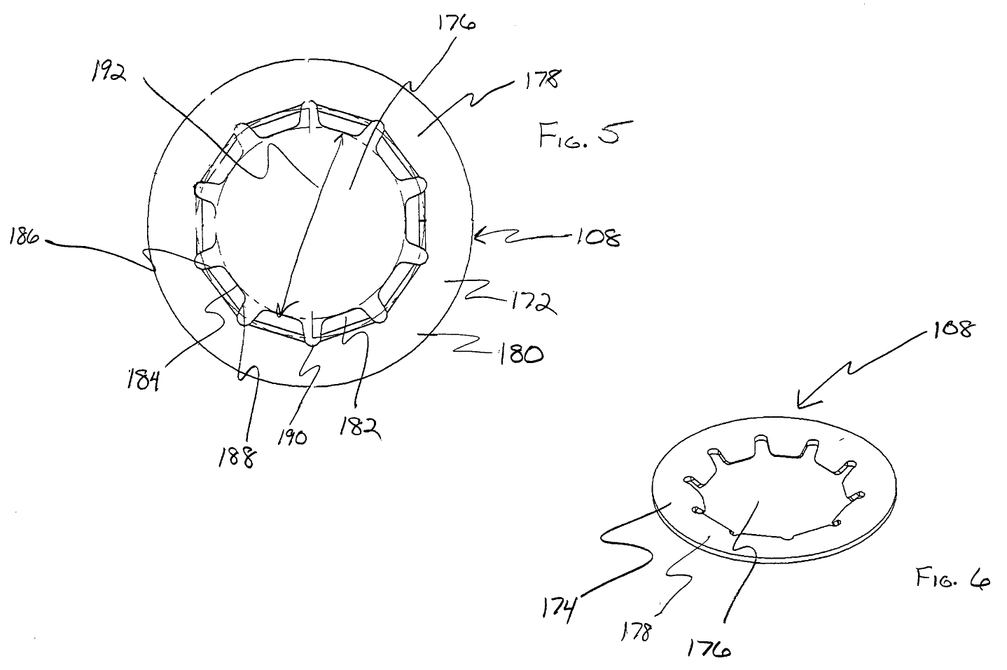

Referring to FIG. 4, tubing 104 can be formed from a polymer, and includes a distal end 160 and a proximal end 162. Tubing 104 further includes a continuous lumen 164 having a distal end 160 and a proximal end 162. The tubing 104 presents an inner diameter 166 and an exterior diameter 168. The difference between inner diameter 166 and exterior diameter 168 defines the thickness of tube wall 170.

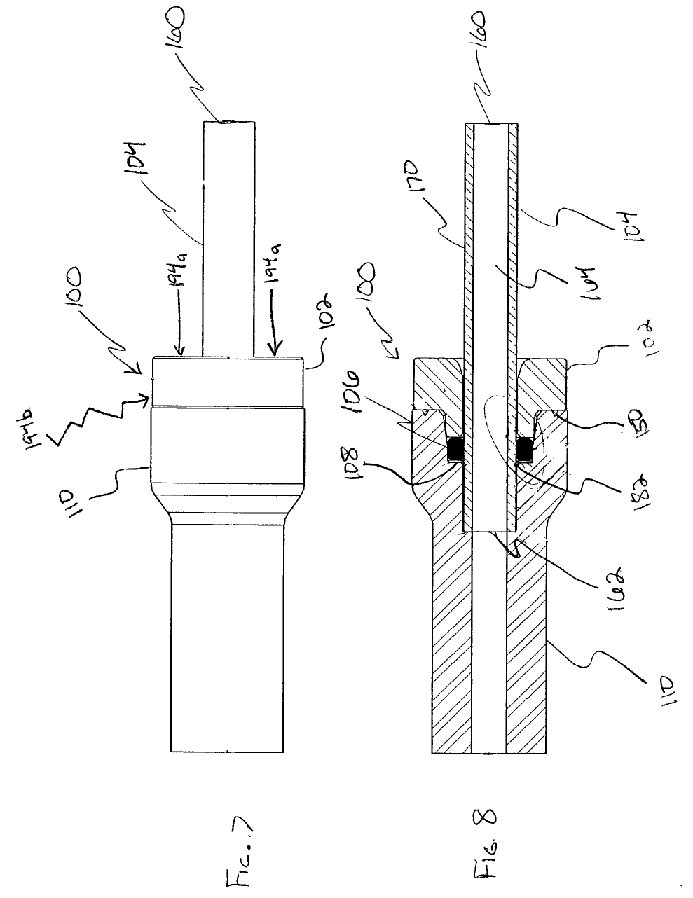

Referring to FIGS. 5 and 6, star washer 108 includes a locking surface 172, a sealing surface 174, and a washer bore 176. Star washer 108 can be formed from a material that is preferably metallic. Locking surface 172 comprises an outer ring 180 and a plurality of teeth 182. Each tooth 182 includes a tip 184 and a pair of projecting edges 186, 188. Teeth 182 are generally inwardly facing and angled so that tip 184 extends outwardly from the locking surface 172. Teeth 182 are distinguished by a tooth void 190 separating projecting edges 186, 188. Opposed tips 184 define a washer diameter 192. In an alternative embodiment, star washer 108 and seal 106 could be combined into a single component.

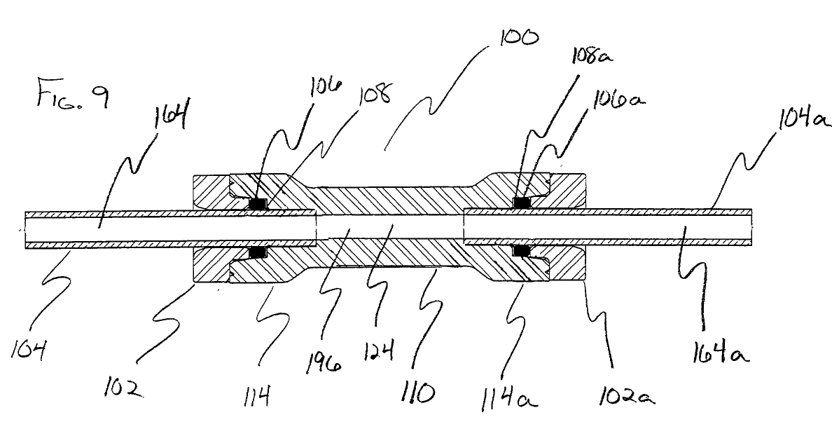

Referring to FIGS. 7 and 8, the preferred embodiment of tube connector 100 is depicted as fully assembled. Looking at FIGS. 7 and 8 in conjunction with FIGS. 2-6, in assembly, the proximal end 162 of tubing 104 is first inserted into retainer 102. Proximal end 162 is guided by tapered retainer surface 156 as tubing 104 is inserted through retainer bore 152. Retainer 102 is oriented so as to have insertion face 148 facing distal end 160 of tubing 104. Proximal end 162 of tubing 104 is then inserted through seal 106.

Next, proximal end 162 of tubing 104 is inserted through washer bore 176 of star washer 108. Star washer 108 should be oriented such that sealing surface 174 faces distal end 160 of tubing 104. Exterior diameter 168 of tubing 104 is slightly larger than washer diameter 192 such that teeth 182 will flex outward in the direction of the proximal end 162 of tubing 104. Once proximal end 162 is clear of teeth 182, the insertion of tubing 104 should cease. It is to be recognized that in some applications, it may be preferable to alter the order of insertion such that seal 106 is the last component through which tubing 104 is inserted rather than star washer 108.

Once retainer 102, seal 106 and star washer 108 have been placed over tubing 104, proximal end 162 of tubing 104 is inserted into receiver bore 118 of manifold 110. As proximal end 162 is inserted, star washer 108 will come into physical contact with seal face 138. Star washer 108 will remain in physical contact with seal face 138 as tubing 104 is inserted further into receiver bore 118. Tubing 104 continues insertion through washer bore 176 as tubing 104 is traveling in the direction of the teeth 182.

Proximal end 162 is capable of insertion until proximal end 162 comes into physical contact with tube face 140. At this point, tubing 104 cannot be withdrawn through star washer 108 as the teeth 182 grip the tube wall 170 to prevent travel of the tubing 104 in the direction of the distal end 160. Exterior diameter 168 of tubing 104 is slightly larger than third diameter 130 of manifold 110. This causes tube wall 170 to physically abut tube face 140 of manifold 110 preventing further insertion of tubing 104. Exterior diameter 168 is smaller than second diameter 128 such that tube wall 170 is in close contact with tubing interface surface 134.

Once tubing 104 has been fully inserted into manifold 110, a force applicator 194 (not shown) may be brought into contact with the insertion face 148 of retainer 102. The force applicator preferably has jaws for substantially encircling the retainer 102 and adjacent portion of the manifold 110. Force applicator 194 applies a leftward-directed compressive force, depicted by arrows 194a in FIG. 7, to insertion face 148 causing retainer 102 to slide over tubing 104 toward manifold 110. As retainer 102 slides over tubing 104, the compression face 144 on annular boss 151 contacts seal 106. As compression face 144 enters receiver bore 118, tapered manifold surface 132 serves to center retainer 102 within receiver bore 118. Further travel of retainer 102 will be prevented once insertion face 148 comes into contact with manifold coupling face 120 of manifold 110. At this point, weld insert 150 will be projecting into weld receiver 122.

Force applicator 194 is then used to apply a circumferential sonic force, depicted by arrow 194b in FIG. 7, to the retainer 102 to effect an annular sonic fusion weld between retainer 102 and manifold 110. The force applicator 194 causes weld insert 150 to vibrate at a high rate of speed across weld receiver 122. This vibration leads to frictional heating causing weld insert 150 to melt into weld receiver 122. As weld insert 150 melts, the compressive force supplied by force applicator 194 causes further insertion of retainer 102 until retainer coupling face 146 comes into physical contact with manifold coupling face 120. As retainer 102 is fully inserted, seal 106 is compressed between compression face 144, star washer 108, tube wall 170, and tapered manifold surface 132. When fully compressed and sonic fusion is complete, seal 106 provides a fluid tight seal between manifold 110 and tubing 104. Once insertion of retainer 102 is accomplished, the jaws of the force applicator 194 are opened and the force applicator 194 is withdrawn.

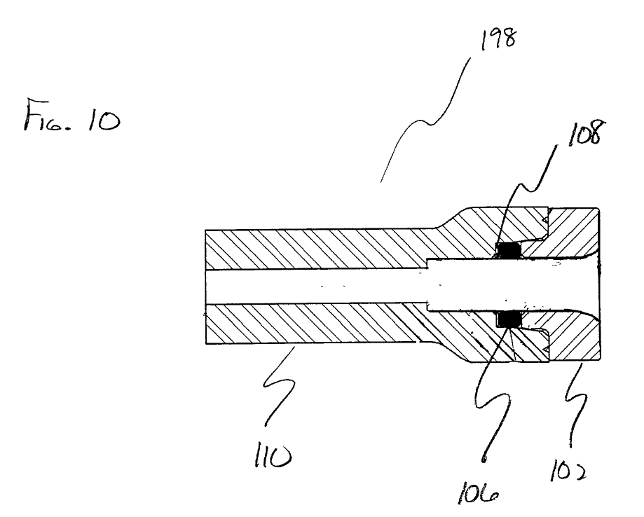

An alternative embodiment of an assembled tube connector 100 is depicted in FIG. 9. In this embodiment, manifold 110 includes a plurality of attachment ends 114, 114a. This alternative embodiment uses a pair of retainers 102, 102a, a pair of seals 106, 106a and a pair of star washers 108, 108a to join two lengths of tubing 104, 104a. When completed, the tube connector 100 creates a single fluid throughbore 196 comprised of lumens 164, 164a and manifold bore 124.

Another alternative embodiment of the tube connector of the present invention is depicted in FIG. 10. FIG. 10 depicts a connector assembly 198 comprised of retainer 102, seal 106, retainer 108 and manifold 110. Connector assembly 198 is fully assembled absent the presence of tubing 104. Connector assembly 198 can then be forwarded to a second manufacturing site where a user can install tubing 104 through a simple insertion force rather than requiring the presence of force applicator 194.

It will be obvious to those skilled in the art that other embodiments in addition to the ones described herein are indicated to be within the scope and breadth of the present application. Accordingly, the applicant intends to be limited only by the claims appended hereto.

What is claimed:

1. An apparatus for creating a permanent and fluid tight tube joint in a length of plastic tubing, said tubing including a terminal end, the apparatus comprising:
a manifold for receiving said plastic tubing, the manifold including structure defining a first counterbore presenting a tubing terminal end engaging face, structure defining a second counterbore presenting a seal engaging face, and
said manifold further presenting a manifold coupling face;
a seal receivable within said second counterbore;
a gripping element receivable within said manifold and adapted for fixedly engaging said tubing; and
a retainer including a compressive member and a retainer coupling face, said retainer compressive member receivable within said second counterbore for operably, compressively engaging said seal, said retainer coupling face and said manifold coupling face being mutually abuttably oriented when said retainer compressive member is received within said second counterbore, whereby said manifold coupling face and said retainer coupling face can be operably fixedly coupled together to permanently attach said retainer and said manifold together with said seal compressed to provide a fluid tight coupling of said tubing with said manifold.

2. The apparatus of claim 1 wherein the gripping element comprises a star washer.

3. The apparatus of claim 1 wherein the sealing element comprises an elastomeric o-ring.

4. The apparatus of claim 1 wherein the seal comprises a star washer with an overmolded, elastomeric seal.

5. The apparatus of claim 1 wherein the second counterbore includes a guiding surface for positioning the retainer.

6. The apparatus of claim 1 wherein the compressive member of the retainer is aligned with the seal to impart a radial stress to the plastic tubing.

7. The apparatus of claim 1 including one or more protruding surfaces on either the manifold coupling face or the retainer coupling face that mate with one or more depressions on the corresponding retainer coupling face or manifold coupling face.

8. The apparatus of claim 7 wherein the protruding surfaces and depressions act as an energy concentrator during sonic welding of the retainer to the manifold.

9. A method for creating a permanent and fluid tight tube joint in a length of plastic tubing, said tubing including a terminal end, the method comprising:
inserting the tubing terminal end through a retainer;
inserting the tubing terminal end through a seal;
inserting the tubing terminal end through a gripping element;
slidably inserting the tubing terminal end into structure defining a counterbore of a manifold;
applying a compressive force to the retainer such that a retainer coupling face is directed into proximity with a manifold coupling face and the seal is directed into proximity with a manifold internal surface; and
applying a sonic force to the retainer to operably fixedly couple one or more portions of the retainer coupling face with one or more portions of the manifold coupling face.

10. The method of claim 9 including forming the seal of an o-ring.

11. The method of claim 9 including forming the seal of a star washer with an overmolded, elastomeric seal.

12. The method of claim 9 wherein the compressive force applied to the retainer results in a radial stress being imparted to the plastic tubing.

13. The method of claim 9 including forming one or more protruding surfaces on either the manifold coupling face or the retainer coupling face and one or more depressions on the corresponding retainer coupling face or manifold coupling face.

14. The method of claim 13 including mating the protruding surfaces with the depressions.

15. The method of claim 13 including transmitting the sonic force through the retainer coupling face.

16. A method for creating a permanent and fluid tight tube joint in a length of plastic tubing, said tubing including a terminal end, the method comprising:
inserting the tubing terminal end through a retainer;
inserting the tubing terminal end through a gripping element;
inserting the tubing terminal end through a seal;
slidably inserting the tubing terminal end into structure defining a counterbore of a manifold;
applying a compressive force to the retainer such that a retainer coupling face is directed into proximity with a manifold coupling face and the seal is directed into proximity with a manifold internal surface; and
applying a sonic force to the retainer to operably fixedly couple one or more portions of the retainer coupling face with one or more portions of the manifold coupling face.

17. The method of claim 16 including forming the seal of an o-ring.

18. The method of claim 16 including forming the seal of a star washer with an overmolded, elastomeric seal.

19. The method of claim 16 wherein the compressive force applied to the retainer results in a radial stress being imparted to the plastic tubing.

20. The method of claim 16 including forming one or more protruding surfaces on either the manifold coupling face or the retainer coupling face and one or more depressions on the corresponding retainer coupling face or manifold coupling face.

21. The method of claim 20 including mating the protruding surfaces with the depressions.

22. The method of claim 20 including transmitting the sonic force through the retainer coupling face.

23. An apparatus for creating a plurality of permanent and fluid tight tube joints in a plurality of lengths of plastic tubing, said tubing lengths each including a terminal end, the apparatus comprising:
a manifold for receiving said plastic tubing, the manifold including structure defining a plurality of first counterbores presenting tubing terminal end engaging faces, structure defining a plurality of second counterbores presenting seal engaging faces, and said manifold further presenting a plurality of manifold coupling faces;
a seal receivable within each said second counterbore;
a plurality of gripping elements receivable within said manifold and adapted for fixedly engaging said tubing; and
a plurality of retainers each including a compressive member and a retainer coupling face, said retainer compressive member receivable within one of said second counterbores for operably, compressively engaging one of said seals, said retainer coupling face and one of said manifold coupling faces being mutually abuttably oriented when said retainer compressive member is received within the second counterbore, whereby the manifold coupling face and said retainer coupling face can be operably fixedly coupled together to permanently attach said retainer and said manifold together with the seal compressed to provide a fluid tight coupling of said tubing with said manifold.

24. The apparatus of claim 23 wherein the gripping elements comprise star washers.

25. The apparatus of claim 23 wherein the sealing elements comprise elastomeric o-rings.

26. The apparatus of claim 23 wherein the seals comprise star washers with an overmolded, elastomeric seal.

27. The apparatus of claim 23 wherein each second counterbore includes a guiding surface for positioning the retainer.

28. The apparatus of claim 23 wherein the compressive member of each retainer is aligned with the seal to impart a radial stress to the plastic tubing.

29. The apparatus of claim 23 including one or more protruding surfaces on either the manifold coupling faces or the retainer coupling faces that mate with one or more depressions on the corresponding retainer coupling faces or manifold coupling faces.

30. The apparatus of claim 29 wherein the combination of protruding surfaces and depressions act as an energy concentrator during sonic welding of each retainer to the manifold.
